(19) United States
(12) Patent Application Publication
(10) Pub. No.: US 2011/0132240 A1
(43) Pub. Date: Jun. 9, 2011

(54) WORKTABLE APPARATUS

(76) Inventor: Frank . Kent, Arles (FR)

(21) Appl. No.: 12/676,631

(22) PCT Filed: Sep. 8, 2008
(86) PCT No.: PCT/GB08/50800

§ 371 Date: Jun. 14, 2010

(51) Int. Cl. B25H 1/14; A47B 13/08; B25H 1/02

(52) U.S. Cl. 108/102; 269/86; 269/290

(57) ABSTRACT

The invention relates to a worktable apparatus employing primary and secondary worktop members (1, 2) whereby the secondary worktop members (2) are pivotable between a first position in which they are co-planar with the primary worktop surface (1), and a second position in which they are operable to releasably hold a workpiece or other item in a plane above the primary worktop surface (1) (see FIGS. 7-10). When in the first position, the respective worktop members (1, 2) present an enlarged planar surface area for supporting larger workpieces (see dashed lines in FIG. 7). When in the second position, the spacing between the respective worktop members (1, 2) is sufficient to allow the secondary worktop member (2) to be moved over items placed on the primary worktop surface (1) and therefore its clamping or holding functions are unimpeded.

The present invention relates to a worktable apparatus and particularly, but not exclusively, to a worktable apparatus employing worktop members pivotable between a first position in which they are co-planar with a primary worktop surface; and a second position in which they are operable to releasably hold a work piece or other item above the primary worktop surface.

Prior to the invention of the well known Black & Decker Workmate®, worktable apparatus tended to be rather heavy and, consequently, of a fixed, non-foldable construction. The clamping function of such worktables was typically provided by a metal vice fastened to the upper worktop surface by bolts, the clamping jaws of which functioned above the level of the worktop surface. In an alternative arrangement, it was also known to attach a vice to one end of the worktable such that the upper, usually wooden, surfaces of their clamping jaws were arranged to be substantially co-planar with the upper surface of the adjacent worktop surface. The upper surfaces of the clamping jaws and the adjacent worktop surface were sometimes provided with apertures allowing the insertion of clamping blocks, such an arrangement facilitating the clamping of an over-sized workpiece between a clamping block at one end of the worktop surface and a clamping block on the tightening jaw of the vice at the opposing end.

An advantage of such conventional worktable apparatus was the availability of a large area worktop surface on which to place auxiliary items such as tools, rulers, set squares, screws, pencils and the like. Clamping of a workpiece could either take place in a vice at an elevated height with respect to the surface of the worktop surface, or in the same plane as the worktop surface at one of its ends. Advantageously, neither of these clamping arrangements would normally necessitate the removal of auxiliary items from the worktop surface. Removal of such auxiliary items would only be required in the case where an over-sized workpiece was being clamped as described above. However, in an attempt to address this problem a lower central trough was provided beneath the worktop surface in which to store the auxiliary items whilst the worktop surface above supported the over-sized workpiece.

The advent of Black & Decker's Workmate® apparatus represented a marked shift in the field of worktable apparatus. The Workmate® provided a significantly scaled down worktop surface divided into two portions, each of which operated as a clamping jaw. The Workmate® provided enormous advantages to users because its clamping jaws extended over its full width and the apparatus was foldable, relatively lightweight and thus easy to transport.

However, the scaled down nature of the worktable also represented a significant disadvantage in that the available horizontal surface area on which to place auxiliary items was greatly reduced. In particular, it is relatively difficult to use the Workmate® apparatus both as a surface for placing auxiliary items and, at the same time, use it for clamping a workpiece.

Some efforts have been made to incorporate storage space for auxiliary items in trays or racks which can be incorporated into the Workmate® worktable's supporting structure. Alternative worktables are sold with an extra piece of worktop which can be inserted between the two clamping jaws to provide a continuous and larger worktop surface area. However, this temporarily renders inoperable the clamping function of the jaws.

According to the present invention, there is provided a worktable apparatus comprising:
a primary worktop member providing, in use, a substantially horizontal upper surface;
two secondary worktop members providing, in use, two substantially horizontal upper surfaces; and
a supporting substructure for supporting the respective worktop surfaces above a floor surface;
   wherein each secondary worktop member is horizontally displaceable relative to the other in a plane above and parallel to the horizontal upper surface of the primary worktop member.

Embodiments of the present invention will now be described, by way of example only, with reference to the following drawings, in which:

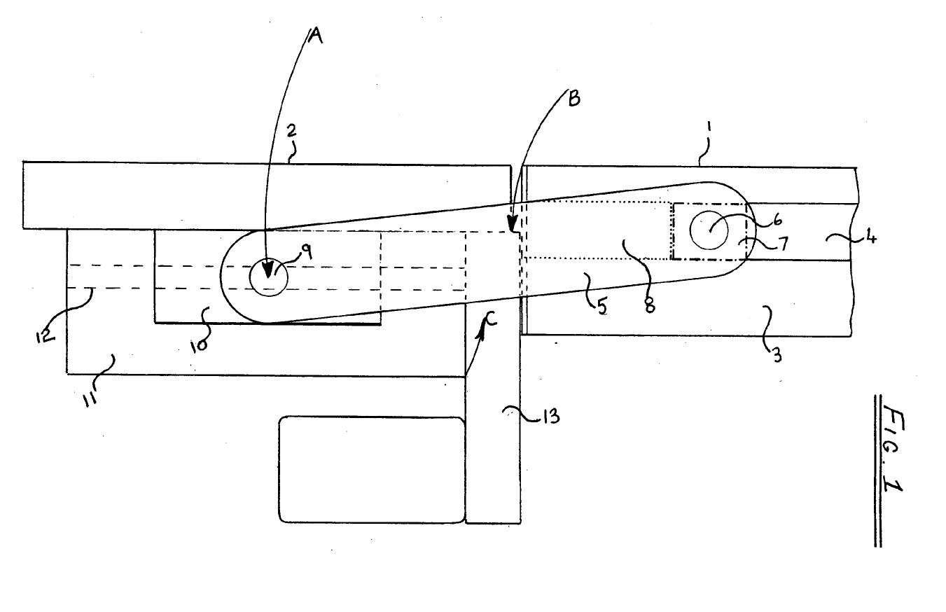

FIG. 1 is a schematic side view of one distal end of the primary worktop surface having a secondary worktop connected thereto and positioned such as to present an enlarged substantially continuous horizontal upper surface;

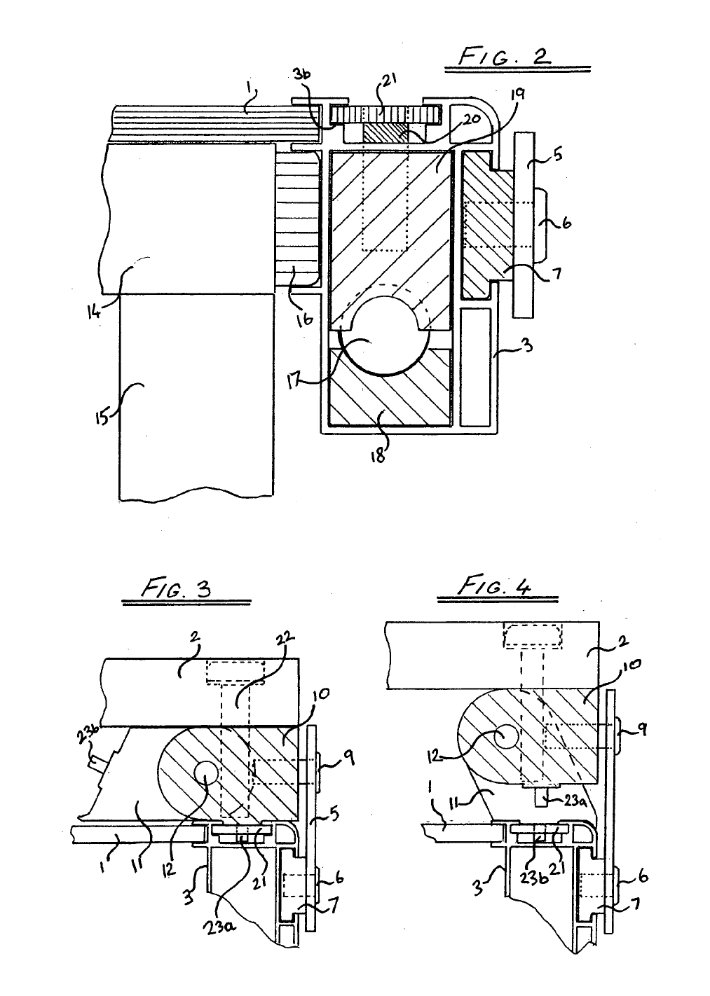

FIG. 2 is an enlarged schematic cross sectional view of a portion of the supporting substructure showing a clamping mechanism;

FIG. 3 is schematic cross-sectional view of the secondary worktop member in its second position overlying the primary worktop member;

FIG. 4 is schematic cross-sectional view of the secondary worktop member of FIG. 3 in its second position overlying the primary worktop member, but with its height adjusted to provide a greater spacing between the respective upper horizontal surfaces of the primary and secondary worktop surfaces;

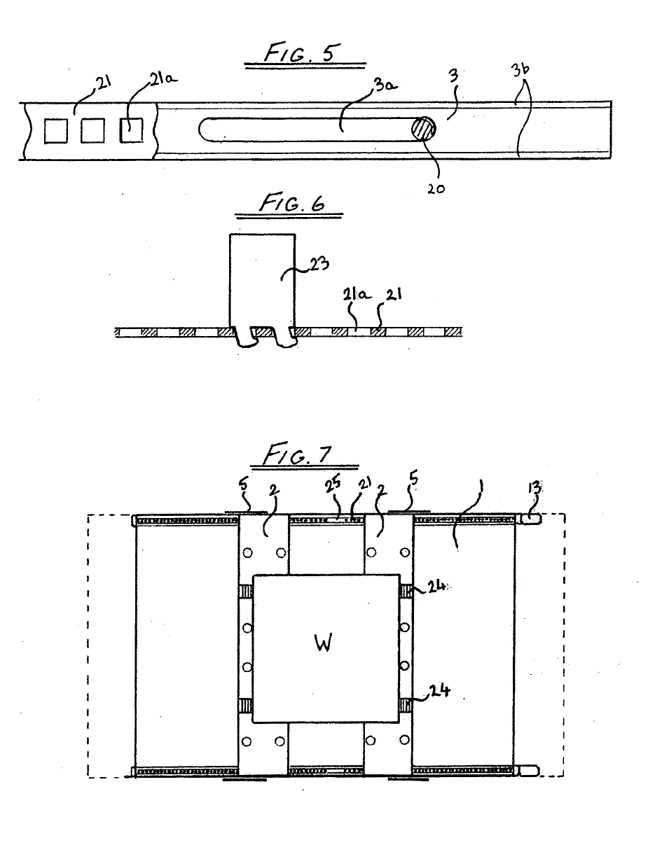

FIG. 5 is a partial schematic plan view of the upper portion of the supporting substructure shown in FIGS. 2-4 showing elements of the clamping mechanism;

FIG. 6 is a partial schematic cross-sectional view showing the connection between a secondary worktop member and the upper portion of the supporting substructure shown in FIG. 5;

FIG. 7 is a schematic plan view of the worktable apparatus in its second position in which the secondary worktop members overlie the primary worktop member and clamp a workpiece, the dotted lines indicating the position of the secondary worktop members when in their first position;

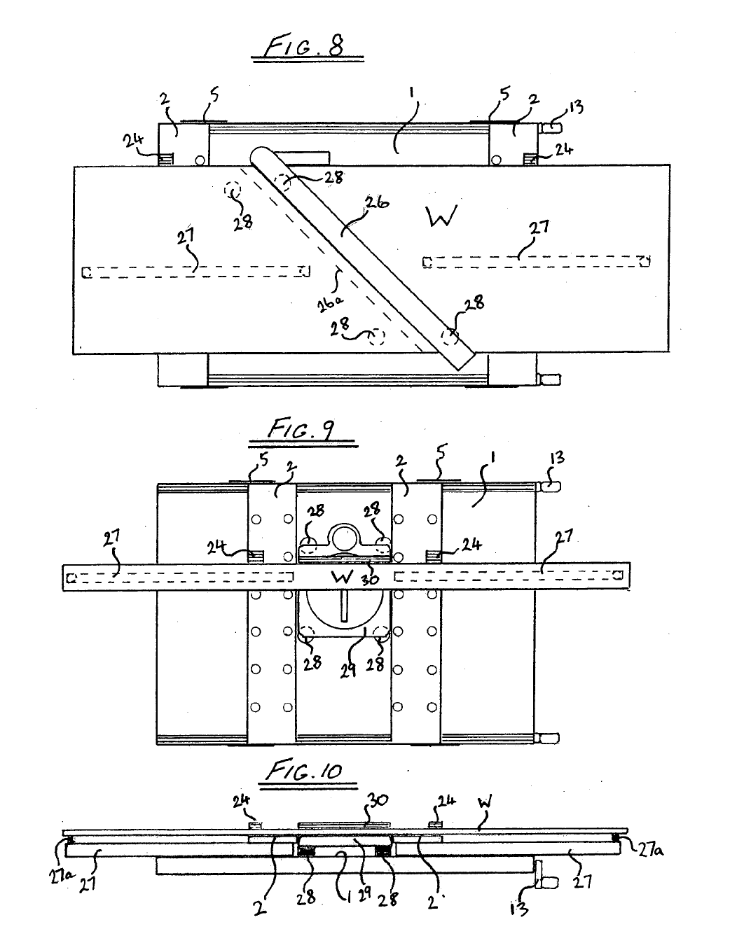

FIG. 8 is a schematic plan view of the worktable apparatus in its second position in which the secondary worktop members overlie the primary worktop member but are spaced well apart to facilitate a 45° cross-cut of a large workpiece;

FIG. 9 is a schematic plan view similar to that of FIG. 7 in which the secondary worktop members are arranged to guide a circular saw beneath a workpiece to facilitate a cross-cut;

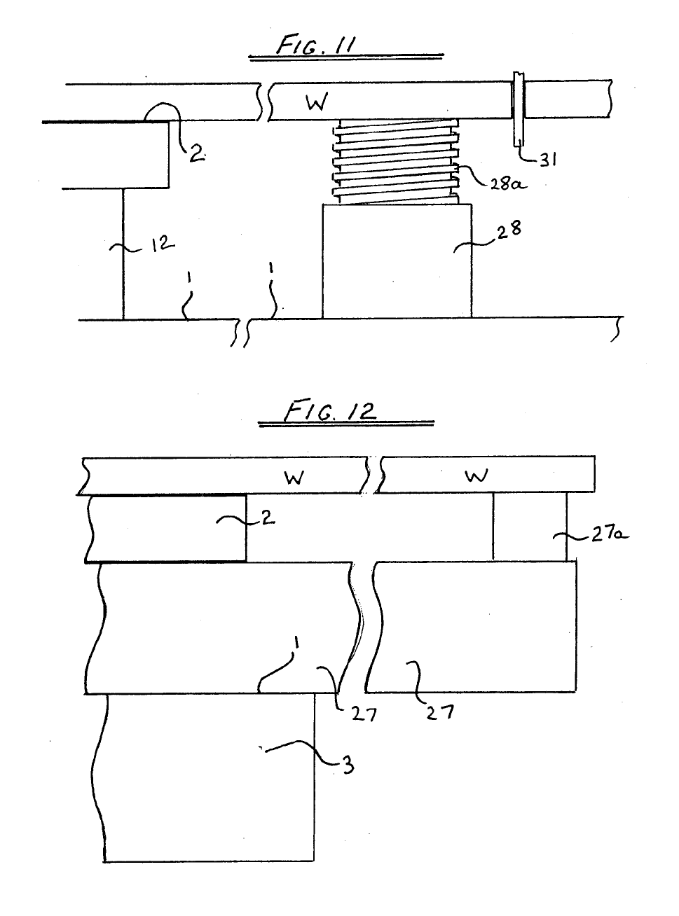

FIG. 10 is a schematic side view corresponding to FIG. 9;

FIG. 11 is a schematic side view of a height-adjustable support member positionable on the upper horizontal surface of the primary worktop to support a workpiece or tool at a user-selected height relative to the upper horizontal surface of a secondary worktop in its second position; and

FIG. 12 is a schematic side view of an alternative height-adjustable support member for supporting a workpiece or tool at a user-selected height relative to the upper horizontal surface of a secondary worktop in its second position.

FIG. 1 shows a schematic side view of one of two distal ends of a worktable apparatus according the present invention. A primary worktop member (1) is supported at a suitable height above an underlying floor (not shown) by a supporting substructure. The primary worktop member (1) presents a substantially horizontal upper surface for supporting work pieces, power tools and other auxiliary items such as hand tools, rulers, set squares, screws, pencils and the like. The opposing longitudinal sides of the primary worktop member (1) are each supported within a framework (3) which, as shown in FIG. 2, is in turn supported on the underlying floor by a folding leg substructure. The folding leg substructure comprises a cross bar (14) bracing apart the legs (15) and the opposing framework lengths (3), and supporting the underside of the primary worktop member (1) across its width. Each distal end of the cross bar (14) terminates in a projecting member (16) which is slidably and pivotably connected to a framework length (3) to allow the legs (15) to be folded and collapsed adjacent the underside of the primary worktop member (1).

A secondary worktop member (2) in the form of a clamping jaw is connected to the primary worktop member (1) by means of a double-axis strut member (5) having pivot axes (6, 9) on its opposing distal ends connected to the framework (3) of the primary worktop member (1), and a jaw mount (10) of the secondary worktop member (2), respectively.

A longitudinally extending channel (4) is provided on the outwardly facing side wall of the framework (3) of the primary worktop member (1). The pivot axis (6) of the double-axis strut member (5) is connected to a slidable member (7) slidably located within the channel (4). The slidable member (7), and hence the pivot axis (6) of the double-axis strut member (5) may be displaced along the length of the channel (4). A stop member (8) at the distal end of the channel (4) serves to limit the displacement of the slidable member (7) for the purpose described in further detail below.

The jaw mount (10) to which the pivot axis (9) of the double-axis strut member (5) is connected is, in turn, pivotably connected about a pivot axis (12) to a height adjustment means in the form of an eccentrically mounted support member (11).

When the secondary worktop member (2) is in the position shown in FIG. 1, its horizontal upper surface is substantially co-planar with the horizontal upper surface of the primary worktop member (1) such that, taken together, both surfaces present a single generally continuous and enlarged horizontal upper surface.

In this position, the secondary worktop member (2) is partially supported on an upper horizontal surface of a clamping handle (13) whilst a side wall of the eccentrically mounted support member (11) abuts tightly against a vertical surface of the clamping handle (13). Further anti-clockwise rotation of the secondary worktop member (2) in the direction of arc A is prevented since such movement serves only to further tighten the eccentrically mounted support member (11) against the clamping handle (13).

The approximately 3 mm gap between the upper surfaces of the respective primary and secondary worktop members (1, 2) as shown in FIG. 1 facilitates the clockwise rotation of the secondary worktop member (2) past the primary worktop member (1) along the line of arc B. In doing so, the secondary worktop member (2) can be selectively operated as a clamping jaw in a plane above that of the upper surface of the primary worktop member (1) as described in further detail below.

Arc C serves to illustrate that any downward pressure on the outer extremity of the secondary worktop member (2) cannot pivot its inner extremity upwards around pivot axis (9) because the eccentrically mounted support member (11) would only be forced more tightly into abutment with the clamping the handle (13). It should be noted that the opposing distal end of the primary worktop member (1) is provided with an element which replicates the shape of the portions of the horizontal and vertical surfaces of the clamping handle (13) necessary for fixing the other secondary worktop member (not shown) in a position equivalent to that indicated in FIG. 1.

FIG. 2 shows an enlarged cross sectional schematic view of the framework (3) which may be formed as a plastics or metal extrusion, but is preferably formed from aluminium. An elongate passage formed in the framework (3) houses a clamping mechanism comprising a short threaded member (17) supported by a plastics element (18). When rotated by means of the clamping handle (13), the threaded member (17) drives a plastics nut member (19) back and forth along the length of the thread. A pin member (20) extends into the passage through a slot formed in the base of an approximately 5 mm deep elongate channel lying above the elongate passage at the top of the framework (3). The pin member (20) is threadably or otherwise connected to the plastics nut member (19). An elongate clamping plate (21) having a thickness of approximately 2.5 mm extends longitudinally along the length of the elongate channel and rests on longitudinal shoulders (3b), also shown in FIG. 5. The pin member (20) extends through a passage (21a) formed in the clamping plate (21) (also shown in FIG. 5) before passing through the aforementioned slot and into the nut member (19).

FIG. 3 shows an enlarged cross sectional schematic view of the secondary worktop member (2) in its second position whereby it has been pivoted to lie in a plane above the upper surface of the primary worktop member (1). The central part of the jaw mount (10) of the secondary worktop member (2) is indicated by shading. The eccentrically mounted support member (11) has been rotated into an orientation in which its vertical height is minimised. In this position, the underside of secondary worktop member (2) lies approximately 25 mm above the upper surface of primary worktop member (1). This arrangement allows the worktable apparatus to be folded more compactly than would otherwise be possible.

The secondary worktop member (2) is connected to its jaw mount (11) by means of a bolt (22). Plate engaging teeth (23a) are provided on a lower portion of the central part of the jaw mount (10). The teeth (23a) are adapted to locate within passages (21a) in the aforementioned elongate clamping plate (21).

FIG. 4 also shows an enlarged cross sectional schematic view of the secondary worktop member (2) in its second position. The eccentrically mounted support member (11) has been rotated about axis (12) into an orientation in which it supports the secondary worktop member (2) in an elevated position as compared to that shown in FIG. 3. By raising the secondary worktop member (2), the teeth (23a) are likewise raised out of engagement with the passages (21a) in the elongate clamping plate (21). Instead, the eccentrically mounted support member (11) can be rotated anti-clockwise into a position allowing an equivalent set of teeth (23b) attached thereto to locate within the passages (21a). This arrangement ensures that the elevated secondary worktop member (2) (i.e. as shown in FIG. 4 or 5) can be driven by underlying clamping mechanism.

In this position, the underside of secondary worktop member (2) lies approximately 35 mm above the upper surface of primary worktop member (1) such that it can be moved over the vast majority of auxiliary items unimpeded whilst enabling the relative position of the clamping jaws to be adjusted for supporting or clamping a workpiece without the need to remove the auxiliary items from the surface of the primary worktop member (1).

FIG. 5 is a partial schematic plan view of the clamping handle end of the upper portion of the framework (3) and, at the left hand side, the underlying clamping plate (21). A slot (3a) approximately 56 mm in length is provided in the base of the elongate channel in the upper portion of the framework (3). The slot (3a) starts approximately 50 mm from the distal end of the primary worktop member (1) proximate the clamping handle (13). The slot (3a) restricts the longitudinal displacement of the secondary worktop member (2) by the clamping mechanism to a distance of 50 mm when it is in its second elevated position. Longitudinal flanges partially close the upper opening of the elongate channel at each side and form the upper wall of a recesses (best shown in FIG. 2) serving to retain the clamping plate (21) within the channel, whilst the shoulders (3b) support it above its base thereby providing space under the clamping plate (21) to accommodate the teeth (23a, 23b) as indicated in FIG. 6.

FIG. 7 is a schematic plan view of the worktable apparatus in its second position whereby the dashed lines at each end of the primary worktop member (1) indicate the positions of the respective secondary worktop members (2) when they are in the positions indicated in FIG. 1. When in this position, the horizontal surface area of the worktable apparatus is maximised and is useful for working on large work pieces, for example, a door.

The secondary worktop members (2) are shown in FIG. 7 fixed at an appropriate distance to clamp a work piece (W) by tightening forward the clamping mechanism by a distance of up to approximately 50 mm using the clamping handle (13) such that the clamping jaw moves towards the middle portion (25) of the framework (3). The secondary worktop members (2) are fixed in position on the framework (3) at their opposite distal ends and clamping blocks (24) are inserted into their upper surfaces serving to hold the workpiece (W) firmly in position.

The procedure by which the worktop apparatus is moved into the second position to clamp a workpiece (W) is as follows. Firstly, a user grasps each secondary worktop surface (2) and moves it from its first position (as indicated by the dashed lines) and fixes it at a selected position spaced above the primary worktop surface (1). The secondary worktop members (2) are manually displaced by the user based upon a visual estimate of the size of the work piece (W) to be clamped between their respective clamping edges. Using one hand, the user then holds the workpiece (W) between the respective clamping edges whilst simultaneously using the other free hand to turn first one and then the other of the clamping handles (13) until the respective clamping edges fully converge on, and firmly clamp, the workpiece (W).

FIG. 8 is a schematic plan view of the worktable apparatus whereby the secondary worktop members (2) have been spaced widely to allow a large work piece (W) to be cross-cut at an angle of 45° with a circular saw (not shown). The wide spacing of the respective secondary worktop members (2) is achieved by partially pivoting the double-axis strut member (5) (in a clockwise direction as shown in FIG. 1) by an amount sufficient to permit its longitudinal displacement (to the right in FIG. 1) to a position whereby it can be supported on a distal end of the primary worktop member (1).

The full nature of the co-operational functionality between primary and secondary worktop members (1, 2) is illustrated by the following features: (i) the wide opening and higher level of the secondary worktop members creates a space under the work piece (W) where a saw blade can cut along dotted line (26a) following guide (26) without damaging underlying surfaces or objects; (ii) user-positionable height adjustable supports (28) supported on the upper surface of the primary worktop member (1) (see FIG. 11) which prevent the work piece (W) from sagging in the middle; and (iii) extension bars (27) (see FIG. 12) which support the ends of the work piece (W) are positioned between, and held in position by, the respective upper and lower surfaces of the primary and secondary worktop members (1, 2), respectively.

FIGS. 9 and 10 provide schematic plan and side views respectively of an arrangement of the worktable apparatus for cross-cutting a work piece (W) using a circular mitre saw (29) (base plate only is shown). The closer spacing (as compared to FIG. 8) of the respective secondary worktop members (2) is achieved by fully pivoting the double-axis strut member (5) (in a clockwise direction as shown in FIG. 1).

The top surface of the mitre saw base plate (29) is aligned with the upper surfaces of the secondary worktop members (2) by means of height adjustable supports (28) (see FIG. 11). The secondary worktop members (2) are then tightened together to hold the mitre saw base plate (29) in position. The mitre saw has also been positioned so that its fence guide (30) is aligned with clamping blocks (24) inserted into the upper surfaces of the secondary worktop members (2). The extension bars (27) are again employed to support the ends of the workpiece (W). Spacer members (27a) are provided each of which are equivalent to the thickness of the jaw to provide additional support at the distal ends most remote from the secondary worktop members (2).

FIG. 11 shows a schematic side view of a height adjustable support (28) of the type referred to above supporting a work piece (W) proximate the cutting point of a blade of a circular saw (31). The height adjustable support (28) comprises a threaded inner portion (28a) which may be extended or retracted by means of its threaded engagement within its outer casing. Such height adjustable supports (28) may also be used to align the top of the base plate of a bench tool, for example mitre saw, with the top of the secondary worktop members (2).

FIG. 12 is a schematic side view of an extension bar (27) of the type referred to above positioned between, and held in position by, the respective upper and lower surfaces of the primary and secondary worktop members (1, 2), respectively. Spacer members (27a) having a height equivalent to the thickness of the secondary worktop members (2) are provided on the extension bar (27) and serve to support the work piece (W) in the plane of the upper surfaces of secondary worktop members (2). The spacer members (27a) may be removed and repositioned on the extension bar (27) in a suitable position. Extension bars (27) fitted between the respective primary and secondary worktop members may also be provided with leg supports, guides, rollers or other attachments known in the art for holding or guiding a workpiece.

It will be appreciated that the present invention provides a lightweight, compact, easily transportable and highly adaptable worktable apparatus. The invention may provide a worktable surface only, or be adapted to provide convergeable clamping jaws which overlie a primary worktable surface, and which may be fixed in position by the user to facilitate the working of a work piece at an appropriate height.

Modifications and improvements may be made to the foregoing without departing from the scope of the invention as defined by the claims. In particular, the specific dimensions of the secondary worktop member (2) and their spacing from the primary worktop member (1) are indicative only and can be modified as required.

1. A worktable apparatus comprising:
a primary worktop member providing, in use, a substantially horizontal upper surface;
two secondary worktop members providing, in use, two substantially horizontal upper surfaces; and
a supporting substructure for supporting the respective worktop surfaces above a floor surface;
wherein each secondary worktop member is horizontally displaceable relative to the other in a plane above and parallel to the horizontal upper surface of the primary worktop member.

2. A worktable apparatus as claimed in claim 1, wherein each secondary worktop member is displaceable between a first position in which its upper horizontal surface is maintained substantially co-planar with that of the primary worktop member, and a second position in which its upper horizontal surface overlies the primary worktop surface; and wherein, horizontal displacement of each secondary worktop member takes place when the respective secondary worktop members are in said second position.

3. A worktable apparatus as claimed in claim 1, wherein connection means connect each secondary worktop member to the primary worktop member proximate the distal ends thereof.

4. A worktable apparatus as claimed in claim 1, wherein each secondary worktop member is pivotably connected to the primary worktop member by a double-axis strut.

5. A worktable apparatus as claimed in claim 1, wherein the respective secondary worktop members can be fixed in said first position to provide, in combination with the upper horizontal surface of the primary worktop member, an enlarged and substantially continuous horizontal worktop surface.

6. A worktable apparatus as claimed in claim 1, wherein the respective secondary worktop members are provided with convergeable clamping edges to facilitate the clamping of a workpiece (W) or tool when they are in said second position.

7. A worktable apparatus as claimed in claim 1, wherein height adjustment means are provided on each secondary worktop member to vary the spacing of the respective upper horizontal surfaces of the primary and secondary worktop members.

8. A worktable apparatus as claimed in claim 1, wherein in said second position, the maximum spacing of the respective upper horizontal surfaces of the primary and secondary worktop members is adapted to be at least 35 mm to allow the secondary worktop members to pass over auxiliary items placed on the primary worktop member.

9. A worktable apparatus as claimed in claim 1 further comprising a support member held between the upper horizontal surface of the primary worktop and the underside of a secondary worktop surface to support a workpiece (W) or tool at a user-selected height relative to the upper horizontal surface of a secondary worktop in its second position.

10. A worktable apparatus as claimed in claim 9, wherein the support member is elongate and adapted to extend beyond the footprint of the primary worktop member whilst still supporting a workpiece (W) or tool.

11. A worktable apparatus as claimed in claim 10, wherein the support member is provided with a leg support to support its distal end on the floor surface.

12. A worktable apparatus as claimed in claim 10, wherein the support member is provided with a spacer member having a height equivalent to the depth of each secondary worktop member.

13. A worktable apparatus as claimed in claim 9, wherein the support member is height adjustable.
